(19) United States
(12) Patent Application Publication
(10) Pub. No.: US 2013/0298090 A1
(43) Pub. Date: Nov. 7, 2013

(54) NETWORK RESISTOR MODEL ANALYSIS TOOL

(71) Applicants: Joseph A. Gmitter, Allentown, PA (US); Shawn Boshart, Grantville, PA (US)

(72) Inventors: Joseph A. Gmitter, Allentown, PA (US); Shawn Boshart, Grantville, PA (US)

(73) Assignee: LSI CORPORATION, Milpitas, CA (US)

(21) Appl. No.: 13/462,539

(22) Filed: May 2, 2012

(51) Int. Cl. G06F 17/50

(52) U.S. Cl. 716/102

(57) ABSTRACT

The invention may be embodied in a network resistor model analysis tool for an Electrical Rule Checking (ERC) system. The network resistor model analysis tool typically includes, but need not be limited to, (i) a recursive, deterministic resistor path algorithm that identifies all valid resistor paths from a start net to a stopping net in a netlist corresponding to an analog circuit, (ii) a programming representation algorithm complete for representing the resistor paths in a programmatic format accessible through an application program interface, and (iii) a recursive, deterministic resistance value algorithm that solves the programmatically represented network to determine a total resistance value for each valid path and each resistor leg in each valid path.

### TECHNICAL FIELD

The present invention relates to analog electrical circuit design tools and, more particularly, to a network resistor model analysis tool for an Electrical Rule Checking (ERC) system providing recursive, deterministic search and resolution algorithms and programmatic representation of resistor networks between two points in an analog circuit netlist.

### BACKGROUND

In order to ensure that electrical specifications are met in an analog circuit design, software tools are used to model and verify circuit topology and device parameters. Electrical Rule Checking (ERC) methodologies are a collection of software tools, algorithms, and rules that perform checking of analog circuits to ensure that devices are protected from unintended electrical events, for example Electro-Static Discharge (ESD) events. Resistor network analysis is an aspect of an accurate and complete ERC methodology providing the ability to identify and solve resistor networks in order to identify circuit devices of interest and check parameters against ESD rules. Resistor network analysis is also used to identify specific devices that are susceptible to ESD failures and require further topological checking. Additionally, analog circuit topological checking involves the search for ESD protection devices, of which an accurate resistance calculation is necessary to determine if the resistance portion of the protection topology is within limits.

The currently available analog circuit design frameworks do not provide a mechanism for recursively identifying and solving resistor networks between two points in an analog circuit topology. In complicated analog circuits, there may be many potential network topologies to consider for possible ESD failure paths. Each potential circuit topology is represented by a different resistor network (also referred to as a path) that may need to be analyzed individually to identify the best circuit topology for a particular analog circuit. Analyzing network alternatives can be a time consuming and somewhat subjective process in which the circuit designer selects particular network configurations for analysis based on experience and intuition. This presents opportunities for potentially vulnerable network configurations, sometimes leading to critical ESD failure. Therefore, a continuing need for improved tools for analog circuit design, modeling and evaluation tools is necessary.

### SUMMARY

The present invention provides a network resistor model analysis tool for use in an Electrical Rule Checking (ERC) system. The network resistor model analysis tool solves the resistor network and resistance calculation gap in currently available Electronic Design Automation (EDA) product offerings in the ERC methodology space. The network resistor model analysis tool applies a recursive traversal of the analog circuit design via a netlist. The tool provides a programmatic representation of all paths of a resistor network between two points, including a total resistance calculation, allowing for additional circuit topology and device parameter analysis. Therefore, the resistor network analysis system is compatible with other ERC products through an application programming interface, which allows the other ERC products to access the resistor network analysis tool to accurately compute the resistor component values for all potential network configurations between two arbitrary nets. By using this invention, a complete, integrated ESD methodology can be defined with the enhanced accurate topology checker as the central entity, passing accurate information to other tools that are part of the methodology flow.

Generally described, the network resistor model analysis tool provides the ability to recursively calculate an accurate resistance value in an ERC methodology for all resistance paths on complex circuitry of any size regardless of the existence of other active and passive devices in the network topology. The network resistor model analysis tool also provides the ability to detect resistive loops in the network topology and avoid double counting the resistor values regardless of the complexity of the circuit and number of resistive loops in an ERC methodology. The network resistor model analysis tool can also be used to transform the information generated from network resistor model analysis into a form that any ERC tool can use as input for performing audits related to electrical rule specifications.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the invention may be better understood with reference to the accompanying figures in which:

FIG. 1 is a functional block diagram of an analog circuit design system utilizing a network resistor model analysis tool.

FIG. 2 is a functional block diagram of the network resistor model analysis tool.

FIG. 3 is a logic flow diagram for determining resistor paths in the network resistor model analysis tool.

FIG. 4 is a conceptual illustration of resistor paths in the network resistor model analysis tool.

FIG. 5 is a conceptual illustration of a programmatic representation of a resistor structure in the network resistor model analysis tool.

FIG. 6 is a conceptual illustration of a programmatic representation of a connection structure forming part of the resistor structure in the network resistor model analysis tool.

FIG. 7 is a logic flow diagram for solving resistor paths in the network resistor model analysis tool.

### DETAILED DESCRIPTION OF ILLUSTRATIVE EMBODIMENTS

The invention may be embodied in a network resistor model analysis tool for an Electrical Rule Checking (ERC) system. The network resistor model analysis tool typically includes, but need not be limited to, (i) a recursive, deterministic resistor path algorithm that identifies all valid resistor paths from a start net to a stopping net in a netlist corresponding to an analog circuit, (ii) a programming representation algorithm for representing the resistor paths in a programmatic format accessible through an application program interface, and (iii) a recursive, deterministic resistance value algorithm that solves the programmatically represented network to determine a total resistance value for each valid path and each resistor leg in each valid path.

A deterministic algorithm behaves predictably and when supplied with a given particular input, reliably produces the same output. The deterministic algorithms of the network resistor model analysis tool can be used to identify and characterize all possible valid paths between two arbitrary nets in an analog circuit represented by a netlist. The programmatic representation of the resistor network is determined by parsing the network and storing resistor parameters and network information as entities in programming code that can be easily accessed by other programmatic functions through an application programming interface (API). The programing representation of the resistor paths preferably reflects critical path and component information for each resistor leg in each valid path, which allows for further downstream analysis of the resistor networks that have been discovered. Finally, the resolution algorithm determines if the programmatically represented network paths can be solved and determines a total resistance value for the path. This allows the resistance values of the different paths to be compared and facilitates further investigation into selected paths to resolve high resistance occurrences.

The network resistor model analysis tool expands the capability of ERC tools by identifying, solving, and storing information about resistor networks. This is a critical piece to a complete and integrated ESD rule checking methodology. The problem that the invention solves is that currently available ESD systems cannot determine the accurate point-to-point resistance when attempting to determine if certain devices are susceptible to ESD events. Also, once the ESD vulnerable devices are found, the network resistor model analysis tool solves the problem of determining the point-to point resistance in the ESD protection topology for those vulnerable devices.

The network resistor model analysis tool is compatible with other ERC products and integrated methodologies through the API exposed for access by other program modules. The network resistor model analysis tool may also be used to produce an accurate audit of electrical rules in a pre-layout flow. In such an implementation, the network resistor model analysis tool results in the identification all resistor paths, total resistance values, and critical path information between two points, thereby providing the capability for further analysis of an analog circuit topology to identify electrical rule violations in an integrated ESD methodology.

The resistor network analysis tool greatly enhances the ERC methodology by providing the ability to further analyze the analog circuit to identify topology and device parameter violations in downstream electrical rule analysis toolsets. There is no known product or methodology available that can perform pre-layout, topological ERC with accurate resistance network identification, representation, and resolution of each valid path to a single resistance value. The resistor network analysis tool enhances the pre-layout ERC capability with accurate resistance calculations as part of an ERC methodology, which greatly reduces the probability of ESD rework during analog circuit layout. In addition, the probability of ESD failure and time to market is reduced as alternative methodologies are no longer needed. The resistor network analysis tool provides for less time consuming, more accurate, and less error prone analog network design. Furthermore, the resistor network analysis tool allows the ESD methodology to be created where topology checking can be used as a central focal core to allow other associated tools to perform more accurately and work together seamlessly.

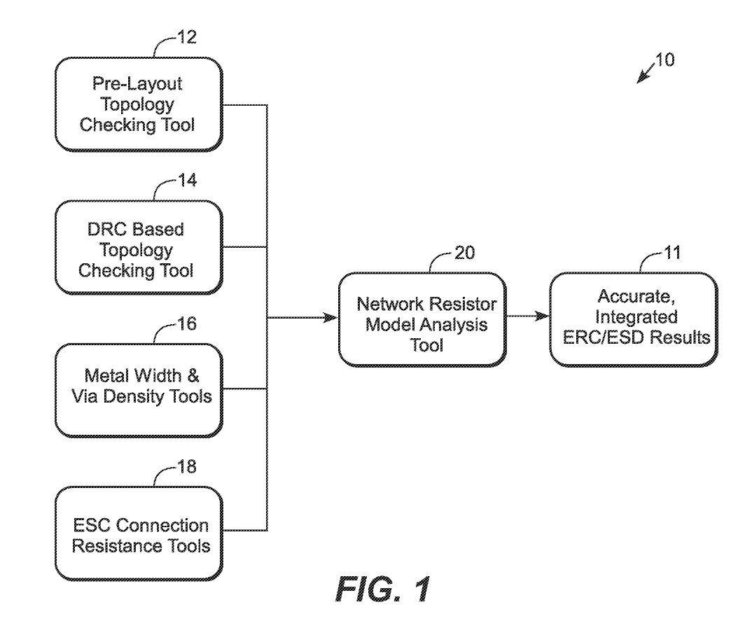

Reference will now be made to the accompanying drawings. FIG. 1 is a functional block diagram of an example of an analog circuit design system 10 utilizing the network resistor model analysis tool 20. This particular analog circuit design system is merely illustrative, as the network resistor model analysis tool may be deployed as a stand-alone tool or as part of any suitable analog circuit design system. However, the elements of the example analog circuit design system are typical and serve to illustrate an ESC environment in which the network resistor model analysis tool may be employed. The analog circuit design system 10 is used to produce accurate, integrated ERC/EDS results 11 and typically includes a pre-layout topology checking tool 12, a DRC based topology checking tool 14, metal width and via density tools 16, and ESC connection resistance tools 18. These tools are integrated with the network resistor model analysis tool 20 to produce the accurate, integrated ERC/EDS results 11. The system tools 12-16 may be conventional or any suitable tools developed in the future and the network resistor model analysis tool 20 is designed to work with any suitable system tools through APIs. As such, the network resistor model analysis tool 20 is not dependent upon, but is specifically configured to work in conjunction with, a wide range of other tools within a variety of analog circuit design frameworks.

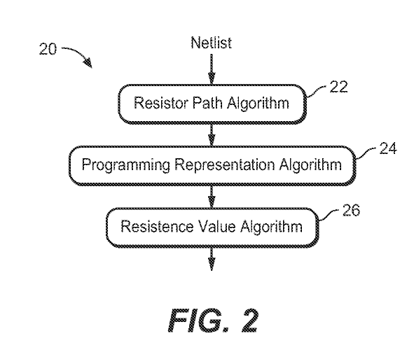

FIG. 2 is a functional block diagram of the network resistor model analysis tool 20, which includes three main components. The first component is a recursive, deterministic resistor path algorithm 22 that receives a netlist defining an analog circuit or a portion of an analog circuit and identifies all potential resistor paths from a start net to a stopping net in the given netlist. In this context, the analog circuit netlist is a programmatic definition of the analog circuit under design analysis which the network resistor model analysis tool 20 accesses to analyze the potential resistor paths from any starting location, referred to as the starting net, to any ending location, referred to as the stopping net, within the analog circuit netlist. The ending result is a complete representation of all potential network paths from the start net to the stopping net.

The second component of the network resistor model analysis tool 20 is a programming representation algorithm 24, which writes the definition of each potential network path into a programming representation that can be accessed by other system tools through a suitable API. This allows other system tools to interface with, and gain the benefits of, the network resistor model analysis tool 20 as part of and within the context of the larger analog circuit design system 10.

The third component of the network resistor model analysis tool 20 is a resistance value algorithm 26, which determines whether each resistor path can be reduced to a single resistor and, for those paths the can be solved, computes the resistance value for the path. This algorithm computes the resistance value for each valid path so that the lowest resistance path can be identified and selected for the circuit design. The algorithm may also compute resistance values for each individual resistor leg in each valid path to facilitate identification of ESD vulnerable devices and determination the point-to-point resistance in the ESD protection topology for those devices.

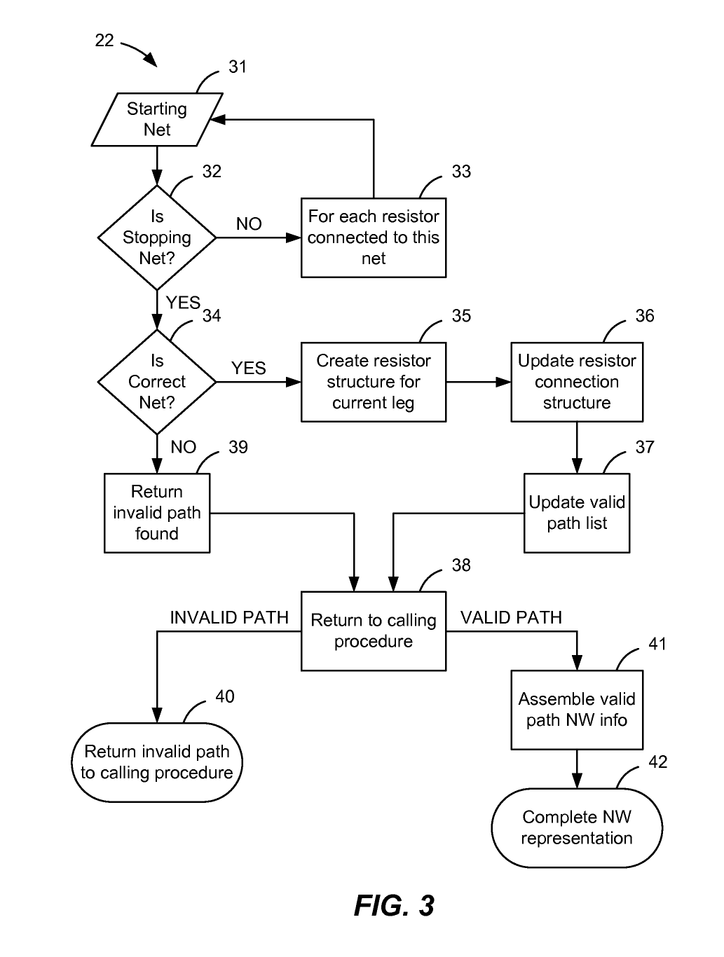

FIG. 3 is a logic flow diagram showing greater detail for the resistor path algorithm 22 shown on FIG. 1. In step 31, the resistor path algorithm 22 obtains the starting net from the netlist at the beginning of the recursive analysis, and then steps through each resistor leg in a prospective path during the recursive analysis. Step 31 is followed by step 32, in which the resistor path algorithm 22 determines whether the element read from the netlist (the current resistor leg) is the stopping net indicating that a complete prospective path has defined. If the element read from the netlist is not the stopping net, the “NO” branch is followed from step 32 to step 33, in which the resistor path algorithm 22 obtains the next resistor leg from the netlist. From step 33, the resistor path algorithm 22 loops back to step 31 until a complete path from the starting net to the stopping net has been defined. This process is repeated for each possible resistor path from the starting net to the stopping net so that each possible path is evaluated.

If the element read from the netlist is the stopping net, the “YES” branch is followed from step 32 to step 34, in which the resistor path algorithm 22 determines whether the resistor path defined by the current iteration is a valid path. A path is determined to be a valid path if it meets the following criteria: (a) the path does not include an individual resistor more than once [no loops]; (b) the path starts at the designated start net and ends at the designated stopping net [correct endpoints]; (c) does not include the start point or the endpoint in the middle of the path; and (d) does not include other device types.

If the path is valid, the “YES” branch is followed from step 34 to step 35, in which the programming representation algorithm 24 creates a resistor structure for current resistor leg. Step 35 is followed by step 36, in which the programming representation algorithm 24 updates the resistor connection structure for the current resistor leg. Step 36 is followed by step 37, in which the programming representation algorithm 24 updates the valid path list. Step 37 is followed by step 38, in which the resistor path algorithm 22 takes an appropriate action depending on whether a valid or invalid path has been found. If the path is not valid, the “NO” branch is followed from step 34 to step 39, in which the resistor path algorithm 22 delivers a “recursive function call return” with an “invalid path found flag” to the calling procedure 38.

Steps 37 and 39 are followed by step 38. In the case of an invalid path, step 38 is followed by step 40, in which the resistor path algorithm 22 delivers a “recursive function call return” with an “invalid path found flag” to the calling procedure. In the case of a valid path, step 38 is followed by step 41, in which the programming representation algorithm 24 assembles the network information for the valid path. Once all of the resistor legs of the valid path have been characterized, step 41 is followed by step 42, in which the programming representation algorithm 24 completes the programmatic representation of the valid resistor path. The resistor path algorithm 22 then delivers a “recursive function call return” with a “valid path found flag” to the calling procedure 40.

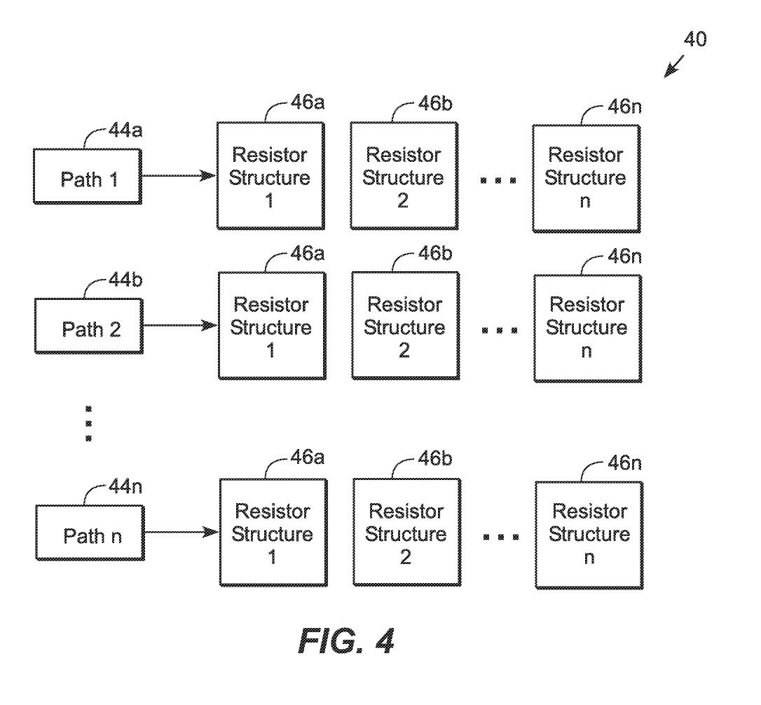

FIG. 4 is a conceptual illustration showing greater detail for the programmatic representation step 24 shown on FIG. 1. This step results in the programmatic representation 40, which includes a resistor structure for each valid path from the start net to the stopping net. Each path 44a-n corresponds to a valid path identified by the resistor path algorithm 22. Each valid path is represented by a series of resistor structures 46a-n in which each resistor leg in the valid path is represented by a respective resistor structure.

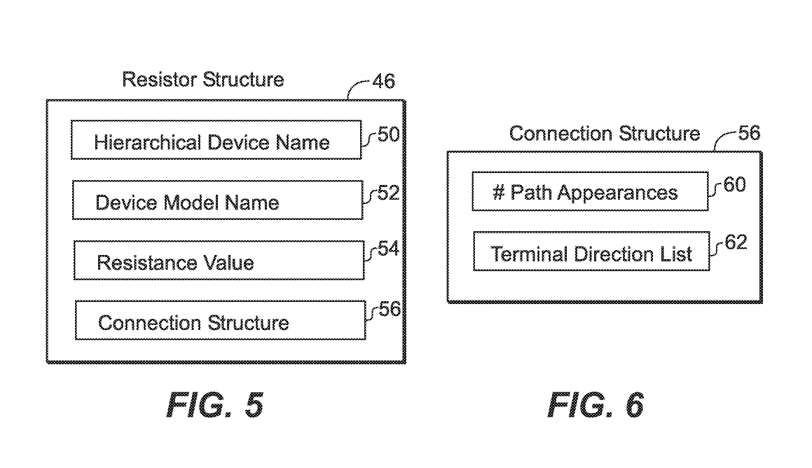

FIG. 5 is a conceptual illustration of the programmatic representation of a resistor structure 46. In this particular example, which is merely illustrative, each resistor leg is represented by a “Hierarchical Device Name” 50. This includes the complete hierarchical name of the resistor, which in this particular example may be presented in the form of “X10/RX_BlockA/XR37.” The resistor structure 46 also includes a “Device Model Name” 52. This is the name given to the resistor model for the particular resistor leg, which in this particular example may be presented in the form of “rhigh.” The resistor structure 46 also includes a “Resistance Value” 54. This is the equivalent resistance of the resistor leg, typically in Ohms, which in the particular example may be presented as “175.27.” The resistor structure 46 also includes a “Connection Structure” 56. This is a programmatic structure that stores information about the individual resistor connection for the resistor leg, which may be in the form of the example shown in FIG. 6.

FIG. 6 is a conceptual illustration of a programmatic representation of the Connection Structure 56. The Connection Structure 56 typically includes an entry for “# Path Appearances” 60. This is a listing of the number of times this resistor appears in the path between the start net and the stopping net. The “# Path Appearances” 60 is typically a numeric value, such as “3.” The connection structure 56 also typically includes an entry for “Terminal Direction List” 60. This is a list for the terminal direction for the resistor leg for each occurrence of the resistor leg in the path. For example, the “Terminal Direction List” may be in the form of “POS, NEG, POS” for a resistor leg with a “# Path Appearances” equal to 3, indicating that this particular resistor leg was encountered at its positive terminal in the first and third resistor legs, and at its negative terminal in the second resistor leg in the path.

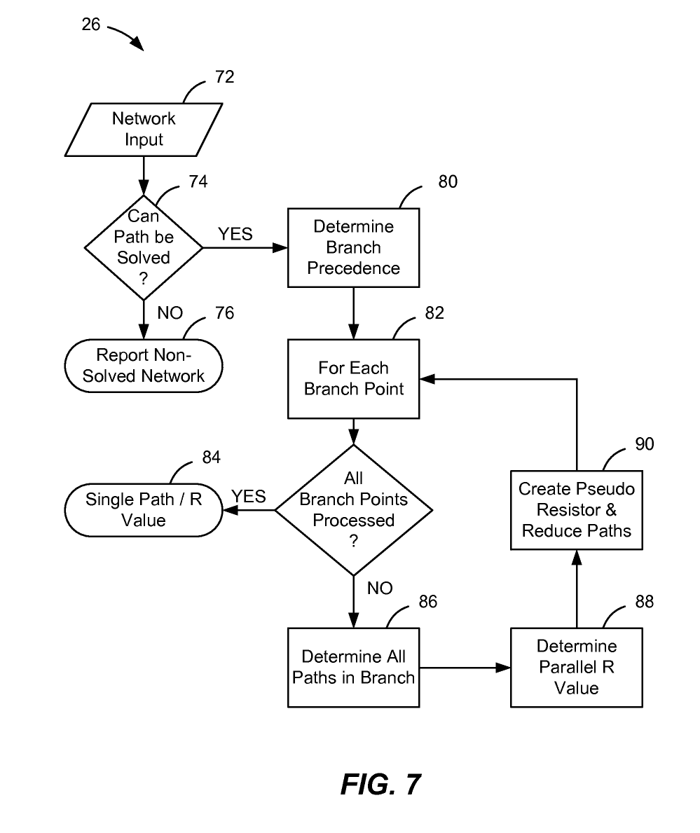

FIG. 7 is a logic flow diagram showing greater detail for the resistor value algorithm 26 shown on FIG. 1. This procedure is repeated for each potential path identified by the resistor path algorithm 22. In step 72, the resistor value algorithm 26 obtains the programmatic network definition 40 for the path under evaluation. Step 72 is followed by step 74, in which the resistor value algorithm 26 determines whether the network can be reduced to a single resistor value. For this step, the resistor value algorithm 26 reviews the resistor structure 46 and the connection structure 56 for each resistor in the path. If the connection structure indicates that a particular resistor was encountered at both terminals (i.e., POS and NEG for the same resistor in the prospective path) then the resistor value algorithm 26 determines that the path cannot be reduced to a single resistor and is not a valid path. In this case, the “NO” branch is followed from step 74 to step 76, in which the resistor value algorithm 26 returns a “Non-Resolved Network” Report.

If, on the other hand, the path can be reduced to a single resistor, the “YES” branch is followed from step 74 to step 80, in which the resistor value algorithm 26 determines the prioritized branch precedence for each resistor leg in the path and records these branch/depth priorities in a programmatically ordered list. Step 80 is followed by step 82, in which the resistor value algorithm 26 evaluates each resistor leg in the path. For each resistor leg, if there is no branch at that leg, then step 82 is followed by step 86, in which the resistor value algorithm 26 determines a resistance value for the non-branching resistor leg.

If there is a branch at the leg, step 86 is followed by step 88, in which the resistor value algorithm 26 determines parallel resistor values for the branches in the path. Step 88 is followed by step 90, in which the resistor value algorithm 26 creates pseudo resistor values for each parallel branch. Step 90 is followed by another iteration of step 82, in which the resistor value algorithm 26 repeats steps 86-90 for each branch in the programmatically ordered list until parallel resistor values have been identified and reduced to a single resistor value. Step 82 is then followed by step 84, in which the resistor value algorithm 26 assigns a single path resistor value to the path under evaluation.

More specifically, in step 80 the resistor value algorithm 26 determines whether the path under evaluation can be reduced to a single resistor. If so, the algorithm examines the resistor structure and the connection structure for each point in the path, determines the precedence/depth of each branch, and records these branch/depth priorities in a programmatically ordered list. In steps 82-90 the algorithm iteratively solves each branch in the programmatically ordered list starting with the inner-most branches prior to solving an outer branch that contains an inner branch.

While there are branch points left in the ordered precedence/depth list, the algorithm performs the following: (a) determine all paths that contain the current branch point and determine at what common node the branch points ends; (b) using established resistance calculation, perform the math functions to determine the parallel resistance across all paths; (c) represent the new parallel resistance with a pseudo-resistor element that replaces the branch in each path; and (d) reduce any resulting duplicate paths in the network structure. Once all of the branches have been reduced to resistor values, the end result is a single path remaining in the network structure, whose resistance is calculated by summing the resistor values the structures in the remaining path.

The present invention may consist (but not required to consist) of adapting or reconfiguring presently existing systems. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is further contemplated that each of the embodiments of the method described above may include any other step(s) of any other method(s) described herein. In addition, each of the embodiments of the method described above may be performed by any of the systems described herein.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Furthermore, it is to be understood that the invention is defined by the appended claims.

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A non-transitory computer readable medium containing computer executable instructions for causing a computer controlled apparatus to perform steps of:
receiving a netlist defining at least a portion of an analog circuit, the netlist including a plurality of parallel resistor paths, the plurality of parallel resistor paths including a plurality of valid paths from a start net to a stopping net within the netlist, each parallel resistor path of the plurality of parallel resistor paths including at least an inner-most branch and an outer branch that contains the inner-most branch;
identifying the plurality of valid paths from the start net to the stopping net in the netlist, wherein each valid path is identified by recursively traversing each parallel resistor path of the netlist until the stopping net is traversed for each parallel resistor path;
recursively traversing the netlist to reduce each valid path to a single resistor value by iteratively solving each branch of each valid path, wherein the inner-most branch of each valid path is solved prior to solving the outer branch of each valid path; and
defining a network resistor model for the analog circuit based upon the single resistor value of each valid path.

2. The non-transitory computer readable medium of claim 1, wherein the step of identifying the plurality of valid paths from the start net to the stopping net in the netlist further comprises the step of storing a complete representation of each valid path from the start net to the stopping net.

3. The non-transitory computer readable medium of claim 1, further comprising a step of representing each valid path as a series of resistor structures in which each resistor structure corresponds to a resistor leg in a valid path and comprises:
a hierarchical device name;
a device model name;
a resistance value; and
a connection structure.

4. The non-transitory computer readable medium of claim 3, further comprising a step of representing the connection structure for each resistor leg in the valid path as a programming representation comprising:
a number of path appearances for the resistor leg; and
a terminal direction list containing a direction indicator corresponding to each path appearance.

5-14. (canceled)

15. A method for creating an analog electrical circuit implemented as computer executable instructions executed by a computer, comprising steps of:
receiving a netlist defining at least a portion of an analog circuit, the netlist including a plurality of parallel resistor paths, the plurality of parallel resistor paths including a plurality of valid paths from a start net to a stopping net within the netlist, each parallel resistor path of the plurality of parallel resistor paths including at least an inner-most branch and an outer branch that contains the inner-most branch;
identifying the plurality of valid paths from the start net to the stopping net in the netlist;
recursively traversing the netlist to reduce each valid path to a single resistor value by iteratively solving each branch of each valid path, wherein the inner-most branch of each valid path is solved prior to solving the outer branch of each valid path;
defining a network resistor model for the analog circuit based upon the single resistor value of each valid path; and
designing a physical analog circuit based at least partially upon the network resistor model.

16. The method of claim 15, wherein the step of identifying the plurality of valid paths from the start net to the stopping net in the netlist further comprises a step of storing a complete representation of each valid path from the start net to the stopping net.

17. The method of claim 15, further comprising a step of representing each valid path as a series of resistor structures in which each resistor structure corresponds to a resistor leg in a valid path and comprises:
a hierarchical device name;
a device model name;
a resistance value; and
a connection structure.

18. The method of claim 17, further comprising a step of representing the connection structure for each resistor leg in the valid path as a programming representation comprising:
a number of path appearances for the resistor leg; and
a terminal direction list containing a direction indicator corresponding to each path appearance.

19-20. (canceled)

21. The non-transitory computer readable medium of claim 1, wherein each valid path is determined to exclude repeated path appearances of an individual resistor.

22. The non-transitory computer readable medium of claim 1, wherein each valid path is determined to include the start net and the stopping net located at respective beginning and end points of each valid path.

23. The non-transitory computer readable medium of claim 1, wherein each valid path is determined to exclude non-resistor device types.

24. The non-transitory computer readable medium of claim 1, further comprising a step of determining whether each valid path is capable of being reduced to a single resistor value.

25. The non-transitory computer readable medium of claim 24, wherein a valid path is determined to be capable of being reduced to a single resistor value based upon a connection structure of each resistor in the valid path.

26. The method of claim 15, wherein each valid path is identified by recursively traversing each parallel resistor path of the netlist until the stopping net is traversed for each parallel resistor path.

27. The method of claim 15, wherein each valid path is determined to exclude repeated path appearances of an individual resistor.

28. The method of claim 15, wherein each valid path is determined to include the start net and the stopping net located at respective beginning and end points of each valid path.

29. The method of claim 15, wherein each valid path is determined to exclude non-resistor device types.

30. The method of claim 15, further comprising a step of determining whether each valid path is capable of being reduced to a single resistor value.

31. The method of claim 30, wherein a valid path is determined to be capable of being reduced to a single resistor value based upon a connection structure of each resistor in the valid path.
